(19) United States
(12) Patent Application Publication
(10) Pub. No.: US 2011/0173819 A1
(43) Pub. Date: Jul. 21, 2011

(54) OPERATING METHOD FOR A POWER TOOL, ESPECIALLY A HAND-HELD POWER TOOL

(75) Inventors: Thilo Koeder, Gerlingen (DE); Joachim Platzer, Remseck-Hochberg (DE); Ulli Hoffmann, Niefern-Oeschelbronn (DE)

(73) Assignee: Robert Bosch GMBH

(21) Appl. No.: 12/992,731

(22) PCT Filed: Mar. 17, 2009
(86) PCT No.: PCT/EP09/53112

§ 371 Date: Feb. 9, 2011

(30) Foreign Application Priority Data
May 15, 2008 (DE) 102008001809.0

(51) Int. Cl. B23D 59/00; B23D 49/10; B23D 51/16; B23Q 17/24

(52) U.S. Cl. 30/376; 173/1; 83/72

(57) ABSTRACT

The invention relates to an operating method for a power tool (1), whereby it is monitored whether the working tool (7) has reached a predetermined position of application relative to a workpiece and whether it has maintained said position of application over a minimum period (t) and the tool (1) is only released for the working operation once the minimum period has expired.

The invention relates to an operating method for a power tool, especially a hand-held power tool.

### TECHNICAL FIELD

Power tools of this kind are known in practice and work in part with auxiliary devices, which support the operator in guiding the power tool along a predetermined working line. Such auxiliary devices are less helpful when commencing the sawing operation and when performing the associated alignment of the power tool with the predetermined working line. This is the case because there is usually no polyline against which the auxiliary device can be placed.

### SUMMARY

The aim of the invention is to point out an operating method, which especially facilitates the critical phase of commencing the sawing operation and also which is suited to mechanize the process of commencing sawing to such an extent that damage is for the most part avoided when the sawing operation is initiated and that the process of commencing sawing does not turn out to be a trial but a precisely aligned application of the power tool to the working line.

This is achieved by the features of claim 1, according to which a sensor-based monitoring of a detection surface on the machine side is used initially to determine whether the working line, along which the operation will subsequently be performed, lies in this detection surface. If this is the case, the position of the working tool to said working line is detected and checked as to whether said position of the working tool aligned to said working line, i.e. the position at which sawing commences, is maintained for a predetermined minimum period. If this minimum period—this can also be very short and approach zero (t→0)—is reached without the given application position of said working tool to said working line having been left in the meantime, the start release of the power tool is initiated. Said power tool can also be permanently active so that the operator decides when to start merely by utilizing the display. The operator is thereby able to meet said working line upon commencing sawing even under critical conditions, whereby multiple trials to correctly apply the tool to said working line, which otherwise might be required, are not necessary; thus enabling damage to the workpiece to be avoided.

Not only the release of a switch, of the power supply in general or also the opening of possible blocking devices is to be understood with the term “start release” but also instructions to the operator that the power tool can now be started. Such instructions can consist of acoustic and/or visual signals.

It is preferred if the detected line of the working tool to the working line is also displayed for the operator, which allows said operator to observe the operation commencing sawing so as to be able to monitor and facilitate said operation.

The method according to the invention is then particularly advantageous if in accordance with the detected position the working tool is itself mechanically displaceable relative to the power tool and is mechanically aligned to the working line. Thus, for example, in the case of jig saws, the saw blade can be rotated with respect to the power tool about an axis of rotation running in its longitudinal direction and upon application to the workpiece is aligned in accordance with acquired location data to the working line, which subsequently follows in the work process while taking the respective detection data into account. Hence, an at least semi-autonomous work operation results, in which the operator has merely to assume responsibility for the support and rough alignment of the power tool.

Because a sufficient perceptibility of the working line, in particular a sufficient contrast to the respective working environment, is necessary for the procedural approach according to the invention, it is advantageous not only for a check to be made whether the respective working line lies within the detection surface and thereby is recognizable at all, but also whether the working line has the necessary definition for a reliable detection, in particular the necessary contrast. In so doing, an automation of the sensor can be carried out and all parameters of the camera, the sensor and the evaluation unit can be set in order to assure optimal preconditions. Not until this is the case does the check ensue as to whether the position at which sawing commences is reached via the guidance of the operator or via the mechanical alignment, said position being held for a minimum period as a requirement for the release of the starting operation.

If, as previously discussed, the correct position of application is not maintained long enough, a signal is thereby sent for the perceptibility of the working line to again be checked.

Because power tools according to the invention too are used in different working conditions and the perceptibility of the working line is not only dependent upon the general degree of visibility but especially upon the background of said working line, it is advantageous if the detection parameters of the sensors, where applicable a video camera or the like, can be modified and therefore be adaptable to the respective actual conditions. Said detection parameters are particularly advantageously modified in a self-regulating and hence automatic and self-learning manner so that a variety of conditions and situations can be covered by the inventive aim without the intervention of the operator.

In addition to the equipment for its mechanical operation, a power tool provided for carrying out this method comprises a sensor array. A signal processing for the values detected by the sensors as well as for values predetermined by the operator is subordinated to said sensor array. A preprocessing of the data which is detected by sensors, particularly via a video camera, takes place in advance, said data being used for signal processing, for checking the reliable detectability of the working line and also for elimination of interfering signals.

In order to optimize the use of the method according to the invention, the power tool is preferably equipped with a working tool which can be displaced about a rotational axis and which is actuated via the signal processing. Especially the area, which is adjacent to the working line and which can be reached via the working tool when it is displaced, is thereby used to actuate the working tool for the application thereof to the working line and for the guidance thereof on said working line.

Regardless of the fact that the equipment of the power tool has a mechanically displaceable working tool, which aligned to the working line follows said line in the work process, it is advantageous if said power tool is equipped with a display field for the user-relevant guide data, if applicable also for other user-relevant information, in order to provide said operator with the option of being able to consciously support said power tool so as to keep it aligned to the working line.

A particularly advantageous embodiment of the power tool is the configuration thereof as a jigsaw.

Other advantages and advantageous embodiments can be derived from the claims, the descriptions of the figures and the drawings. The following are shown:

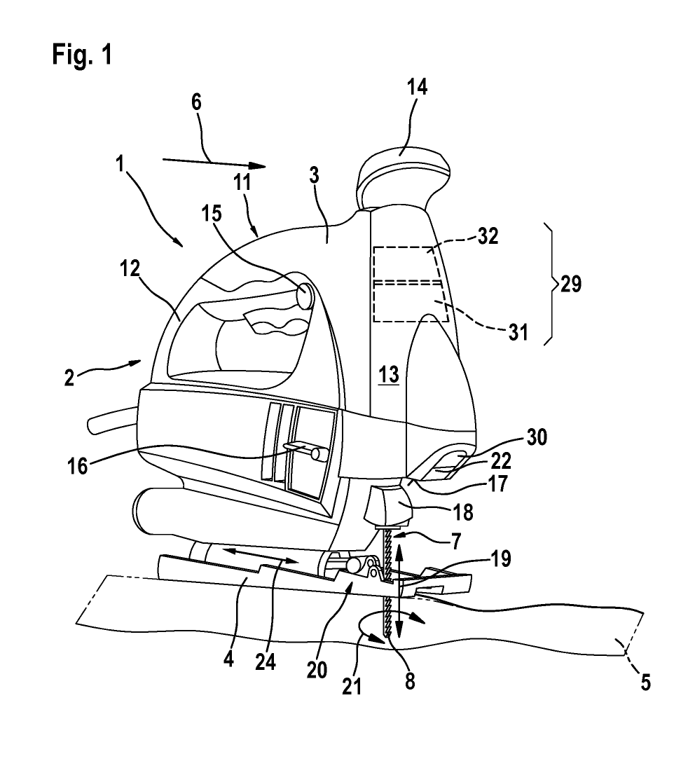

FIG. 1 a power tool in the form of a hand-held jigsaw as an example of a power tool to be operated according to the inventive operating method,

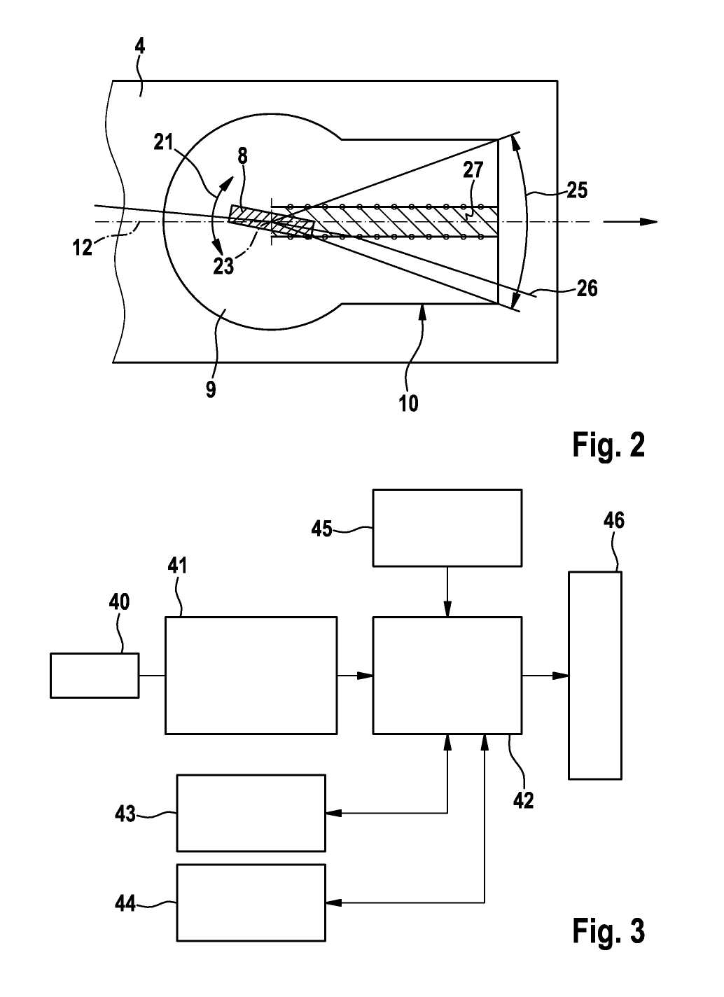

FIG. 2 schematic diagram of a top view of the part of the base plate of the power tool which lies in the working area of the saw blade,

FIG. 3 the depiction of the elements of the power tool, which are linked with one another during the operating method according to the invention, as shown in a block diagram and

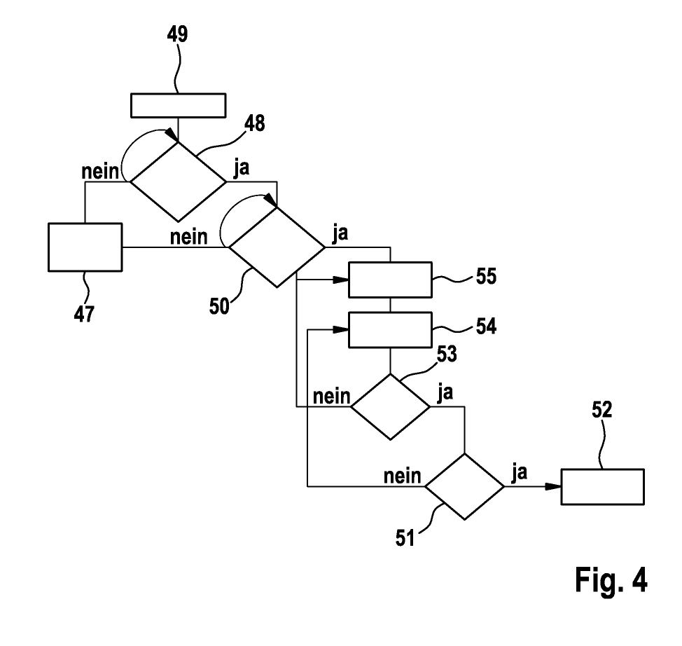

FIG. 4 a flow diagram of the operating method according to the invention.

A jigsaw 2 is provided as the power tool 1, which has a housing 3 and rests on a workpiece 5 via a base plate 4 in a manner that enables it to move. The jigsaw 2 has a saw blade 2 as working tool 8 and the direction of work corresponding to the sawing direction is denoted with the reference numeral 6. Said direction of work 6 corresponds to the direction in which the longitudinal axis 12 of the jigsaw extends when sawing straight ahead.

FIG. 2 also particularly shows that the saw blade 8 penetrates the base plate in a recess, the edges of which define a work area 9 penetrated by the saw blade 8 and a detection surface 10, which in the direction of work lies in front thereof. In so doing, the detection surface 10 also preferably forms a field of vision visible to the operator. A handle 11 as well as a guide knob 14, which overlaps in the front wall area 13 of the housing 3, is provided in the upper region of the housing 3.

A switch assembly 15 lies beneath the handle 11. The unspecified electrical drive motor of the jigsaw 2 can be switched on and off by the operator via said switch assembly 15. Another switching device 16 serves to set various operating modes of said jigsaw 2.

One such operating mode is a base setting, in which the saw blade, which is driven in all operating modes in a reciprocating manner according to arrow 19, extends with its saw blade plane along the longitudinal axis 12 and thereby in sawing direction. In another operating mode, the reciprocating movement mode, the saw blade 8 is additionally driven in an oscillating manner in sawing direction while maintaining this alignment and the reciprocating drive in the direction of its longitudinal extent (arrow 19). The drive related to in this operating model is exemplified by the actuator 20, the reciprocating direction by the arrow 24. A third operating mode, the so-called scrolling mode occurs by means of the rotation of the saw blade 8 about its rotational axis 23 according to arrow 21 when a reciprocating drive is present in the direction of the arrow 19. The pivoting range, which is relevant in practical terms, thereby lies in the magnitude of approximately +/−30E to the longitudinal axis. The rotational axis 23 of the saw blade 8, which is held in the tool holder 18 and can be rotated via an unspecified actuator, also lies on the longitudinal axis 12.

The power tool 1 in the form of a jigsaw 2 is additionally equipped with a sensor array 30 and a signal processing unit 29, which particularly, as indicated, comprises a control unit 32 having a corresponding actuating device and an arithmetic-logic unit 31. The sensor unit 30 is aligned to the detection surface 10. Furthermore, an illumination assembly 22 can be provided for the work area 9 and also if applicable for the detection surface 10. In doing so, it proves to be advantageous to provide the sensor array 30 and the illumination assembly 22 in each case in a transition surface of the front wall area 13 on a reentrant step 17, which lies so as to cover the tool holder 18.

A working line 26 on the workpiece side is illustrated in FIG. 2, with regard to an operation running in the scrolling mode. Said working line 26 runs within the detection surface, has a point of intersection with the rotational axis 23 and the course of which is correspondingly adapted to the saw blade in its rotational position. This alignment to the rotational position takes place via the signal processing unit 29 with the aid of values acquired by means of the sensor array.

FIG. 2 illustrates that corresponding to the size of the pivoting range 25, the sawing direction which corresponds with the rotational position of the saw blade 8 can deviate relatively far from the sawing direction which results when sawing straight down the longitudinal axis 12. Working lines deviating with respect to the longitudinal axis 12 can therefore be semi-autonomously re-traversed in the normal working operation. In doing so, the sawing direction is specified via the alignment of the sawing blade 8 on the working line 26, only a corresponding support being required with respect to the operator.

Assuming the sawing direction already follows a working line 26 in the area where sawing commences, it is advantageous for the sensor-facilitated commencement of sawing on a workpiece 5 at a point of application predetermined by means of said working line 26 if only a limited area 27 of the detection surface 10 is to be used, just as said area 27 is indicated in FIG. 2 as lying symmetrically to the longitudinal axis. This corresponds to a position of the saw blade 8, which is aligned in the direction of sawing at least substantially along the longitudinal axis 12. As a result, the method provided in accordance with the invention is also useful for providing support during the process of commencing sawing in the sense of an assistant aiding in said process of commencing sawing if the power tool 1, hence in this case the jig saw 2, is not equipped with a rotatable saw blade 8 but with one that is disposed in a rotationally fixed manner and is consequently not displaceable in the sawing direction.

In the block diagram according to FIG. 3, the particularly significant functional groups and working members for carrying out the operating method according to the invention are depicted for the explanation of the structure of the control device. The block labeled with the number 40 symbolizes the sensor unit 30 as a video sensor according to FIG. 1. The acquired data are transferred to block 41, which symbolically represents the signal preprocessing, thus particularly the signal processing and line detection functions but also that function for eliminating interfering signals. The signals processed via the signal preprocessing according to block 41 are provided to a signal processing, which is symbolized by block 42, in which the sensor fusion, the validity test and also the evaluation of the items of information and, therefore, also especially the display of said items of information, which do not immediately affect the guidance and alignment of the power tool 1, e.g. in the form of a jigsaw 2. take place. Corresponding modules are illustrated in FIG. 1 by a control unit 32 and an arithmetic-logic unit 31 serving as parts of a signal processing unit 29 for the processing of signals.

FIG. 4 shows the flow diagram of an operating method according to the invention that is optimized for the release of the motor start button. Starting from the state: drive motor for the jigsaw switched off/start button inactive, the evaluation of the visibility and/or contrast resolution of the working line 26 (field 48) initially takes place, wherein said working line 26 is detected by the sensor unit 30 and is fed as video information (field 49). The corresponding check is repeated in the event that the result of the visibility and/or contrast resolution test is negative. If said working line 26 can be flawlessly detected, a check (field 50) is then made to determine whether said working line 26 lies in the detection surface 10. In doing so, this check too is terminated under the precondition: jigsaw switched off/start button inactive (field 47) and if need be repeatedly performed in the event said working line does not lie in the detection surface 10.

If the position of the working line 26 is affirmed to be in the detection surface 10, monitoring is done to determine whether this position is continuously maintained over a predetermined period as a minimum period. The minimum period is acquired in time intervals and in each case elapsed time intervals are added together (field 54—increment counter) until it has been determined that the minimum period has elapsed (field 51—counter>t) and thereby the motor and start release (field 52) takes place.

If the working line 26 departs from the detection surface 10 during the minimum period, this event is then detected (field 53—line in the detection field?) and the respective count is terminated (field 55—counter is reset) and a new measurement of the minimum period is initiated, provided that said working line again lies in the detection surface 10.

1. Operating method for a power tool, especially a hand-held power tool, wherein a working line is predetermined for a working tool on the workpiece side and wherein the overlapping position of a detection surface on the machine side with respect to the working line is monitored by sensors and the position of the working tool with respect to said working line is detected when the position of said working line lies within the detection surface wherein a predetermined minimum period for detecting the position of said working tool with respect to said working line is checked and the start release for the power tool takes place after the minimum period has elapsed.

2. The operating method according to claim 1, wherein the detected position of the working tool with respect to the working line is displayed.

3. The operating method according to claim 1, wherein the working tool is mechanically aligned to the working line in accordance with the detected position of said working tool with respect to said working line.

4. The operating method for a power tool, especially a power tool according to claim 1, wherein the working line is monitored by sensors for the perceptibility thereof, particularly for the presence of and/or the adherence to a minimum contrast value.

5. The operating method according to claim 1, wherein the position of the working line with respect to the detection surface is once again checked when the minimum period for the maintenance of the position of the working tool with respect to said working line is not met; and if the position of said working line lies within the detection surface, a new recording of the minimum period takes place.

6. Power tool, especially a hand-held power tool, especially for carrying out the operating method according to claim 1, wherein the power tool has a sensor unit which is aligned to the detection surface, a signal processing unit for the values acquired by sensors and/or values predetermined by the operator being subordinated to said sensor unit.

7. Power tool according to claim 6, wherein the power tool is equipped with a working tool, which is displaceable in its working direction and is actuated via the signal processing unit.

8. Power tool according to claim 6 wherein the working tool is controlled via the signal processing unit in such a manner that it is aligned to the working line.

9. Power tool according to claim 6, wherein the power tool has at least a display area visible to the operator for the data delivered from the signal processing unit.

10. Power tool according to claim 6, wherein the power tool is configured as a jigsaw, especially as a hand-held jigsaw having a saw blade which is rotatable and mechanically aligned to the working line.
